(19) United States
(12) Patent Application Publication
(10) Pub. No.: US 2016/0008858 A1
(43) Pub. Date: Jan. 14, 2016

(54) CLEANING BRUSH FOR FROTHING CUP

(71) Applicant: Judith M. Runstad, Seattle, WA (US)

(72) Inventor: Judith M. Runstad, Seattle, WA (US)

(21) Appl. No.: 14/678,501

(22) Filed: Apr. 3, 2015

Related U.S. Application Data
(60) Provisional application No. 61/974,783, filed on Apr. 3, 2014.

(51) Int. Cl. B08B 9/087

(52) U.S. Cl. CPC B08B 9/087

(57) ABSTRACT

The present invention relates to a cleaning device for cups or pitchers used in connection with frothing or foaming liquids (e.g., milk or cream) when making a beverage such as a latte or cappuccino. In a preferred embodiment, the device preferably comprises a riser, a handle coupled to a first end of the riser, a foot coupled to a second end of the riser, and a cleaning element attached to the foot. In accordance with the preferred embodiment, the cleaning element may be comprised of a plurality of bristles. The size and angle of the bristles allow the cleaning element to reach the inside corners, edges and surfaces of the frothing vessel to thoroughly and easily clean the residue created by the frothing process that gathers in such areas.

### PRIORITY CLAIM

The present application claims the benefit of U.S. Provisional Application No. 61/974,783, filed Apr. 3, 2014, which is hereby incorporated by reference in its entirety as if fully set forth herein.

### BACKGROUND OF THE INVENTION

The present invention relates to premium beverage systems generally and, more particularly, to a cleaning device for use in premium beverage systems.

When making a premium hot or cold beverage, a user will often steam or froth an ingredient of the beverage before adding it to the beverage. Hereinafter, the terms steam, foam and froth are used interchangeably. The liquid being frothed is contained in a vessel, which is commonly in the form of a pitcher or cup. Hereinafter, the terms vessel, pitcher and cup are used interchangeably.

For example, a barista making a coffee beverage typically uses steam from the steam wand of an espresso machine to heat and froth the milk contained in a pitcher. The foamed milk is then poured from the pitcher into the coffee, which is often in another container, such as a cup or a mug. Similarly, an individual consumer may use an electric or battery-operated stand-alone frother to warm and foam milk for personal consumption of the coffee drink. With the stand-alone devices, the milk is typically heated and frothed by means of rotating elements, such as whisks or gears that agitate the liquid.

In both cases, after the liquid (e.g., milk) is added to the beverage, the frothing vessel needs to be cleaned. Existing brushes or other devices do a poor job of cleaning residue from the vessel. Accordingly, there is a need for a brush or other device that cleans a frothing vessel easily and more thoroughly.

### SUMMARY OF THE INVENTION

The present invention relates to a device that is useful for cleaning frothing vessels in a coffee system. In a preferred embodiment, the device preferably comprises a riser; a handle coupled to a first, or proximate, end of the riser; a foot coupled to a second, or distal end, of the riser; and a cleaning element coupled to the foot. The riser and handle deliver the foot and cleaning element to (or near) the bottom of vessel needing to be cleaned. The size and shape of the cleaning element are such that it can be easily maneuvered to thoroughly clean the residue created by the frothing process that gathers at the corners, edges and surfaces of the vessel.

### BRIEF DESCRIPTION OF THE DRAWINGS

Preferred and alternative embodiments of the present invention are described in detail below with reference to the following drawing figures:

FIG. 1 illustrates schematically, the environment for frothing a liquid using a steam wand;

FIG. 2 illustrates schematically, another environment for frothing a liquid, employing a stand-alone frothing vessel;

FIG. 3 is a side view of a preferred embodiment of the present invention;

FIG. 4 is a perspective view of the present invention shown in FIG. 3 and illustrates an alternative shape;

FIG. 5A is a perspective view of an alternative embodiment of the present invention;

FIG. 5B is a perspective view of another embodiment of the present invention;

FIG. 5C is a perspective view of yet another embodiment of the present invention;

FIG. 5D is a perspective view of still another embodiment of the present invention;

FIG. 6 illustrates schematically, an embodiment of the present invention in use with a frothing vessel;

FIG. 7 illustrates schematically, an embodiment of the present invention in use with a stand-alone frothing vessel; and

FIG. 8 is a top view of a vessel showing an embodiment of the present invention positioned inside the vessel.

### DETAILED DESCRIPTION

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

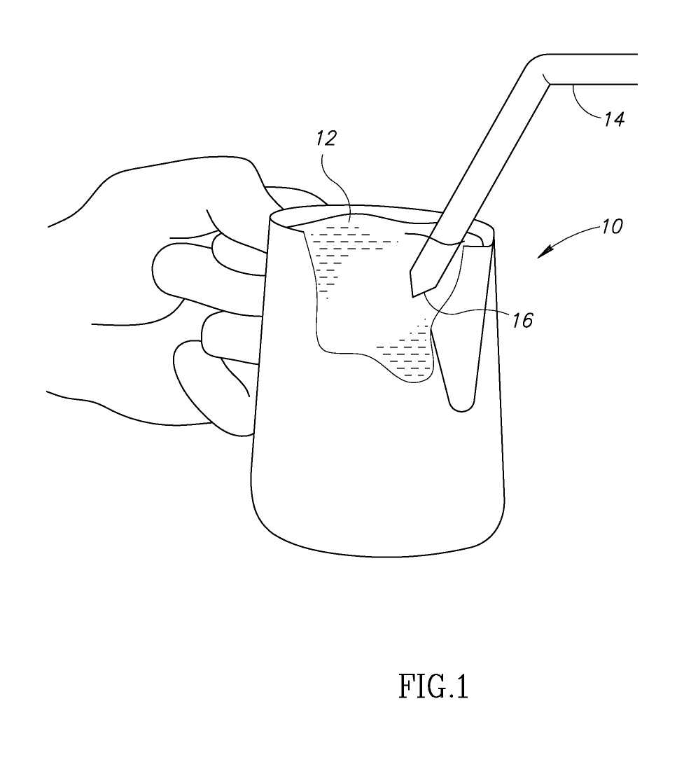

FIG. 1 illustrates schematically, the environment for frothing a liquid, such as milk or cream, before adding it to a beverage, such as coffee or tea, using a steam wand. Vessel 10 is used to hold a liquid 12 (e.g., milk). Steam wand 14 from, for example, an espresso machine (not shown) is inserted into vessel 10 so that tip 16 is in liquid 12. A user then uses steam (not shown) passing from the espresso machine through steam wand 14, which exits tip 16 to heat and froth liquid 12. Once liquid 12 is adequately prepared, steam wand 14 is removed from vessel 10 and the user pours liquid 12 into the beverage (not shown). The user, perhaps a barista or individual home brewer, would normally clean vessel 10 after use.

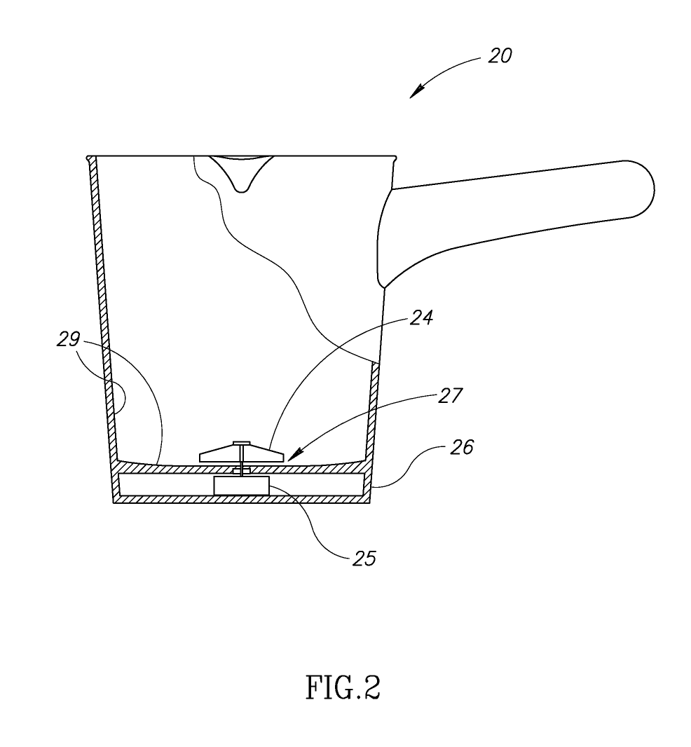

FIG. 2 illustrates schematically, another environment for frothing a liquid, using a stand-alone frothing vessel. In such an application, there is no steam wand. Rather, stand-alone frother 20 heats and foams the liquid (not shown) in frother 20 typically using a stirring device 24 mounted on the base 26 of frother 20 that agitates the liquid. As is shown in FIG. 2, stirring device 24 may be propeller-like in shape and base 26 may house a motor 25 to rotate stirring device 24.

Alternatively, motor 25 may be housed in a removable lid of the stand-alone frother 20 and connected to a rotatable rod (not shown). The rod is inserted into the vessel where it comes into contact with the stirring device 24. Stirring device 24 is then rotated by the rotatable rod to agitate the liquid.

Regardless of the type and variations of stand-alone frother 20, the shape of the base 26 will generally have a raised center portion that causes difficulty in cleaning and removing the residue created from the frothing process along edges 27 of stirring device 24 and inside surfaces 29 of frother 20.

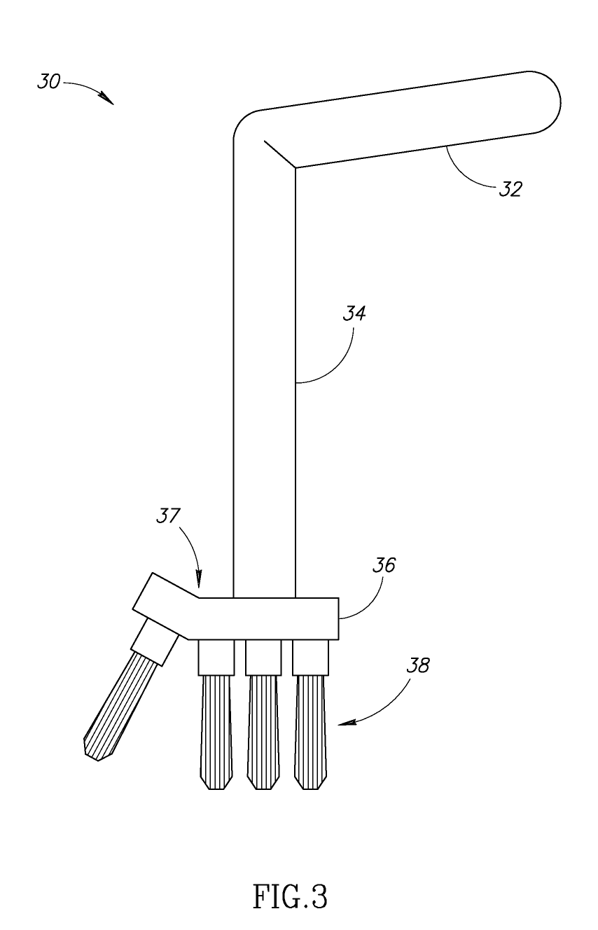

FIG. 3 illustrates a side view of cleaning device 30 according to a preferred embodiment of the present invention and comprises a handle 32, a riser 34, a foot 36, and a cleaning element 38. Handle 32 is coupled to a first, or proximate, end of riser 34 and foot 36 is coupled to a second, or distal end, of riser 34. Handle 32, riser 34, and foot 36 may be one integral structure or may comprise individual components joined permanently or removably. Removable components may allow for easy exchange of such components and may also lead to disposable parts. As illustrated in FIG. 3, foot 36 preferably has attached to it a cleaning element 38 that contacts the bottom of a frothing vessel (not shown). In some embodiments, the foot may be formed with an angular bend 37 permitting it to easily clean different areas of a frothing vessel. Cleaning element 38 may also be integrally formed with foot 36, or may be removably attached for ease of replacement or cleaning.

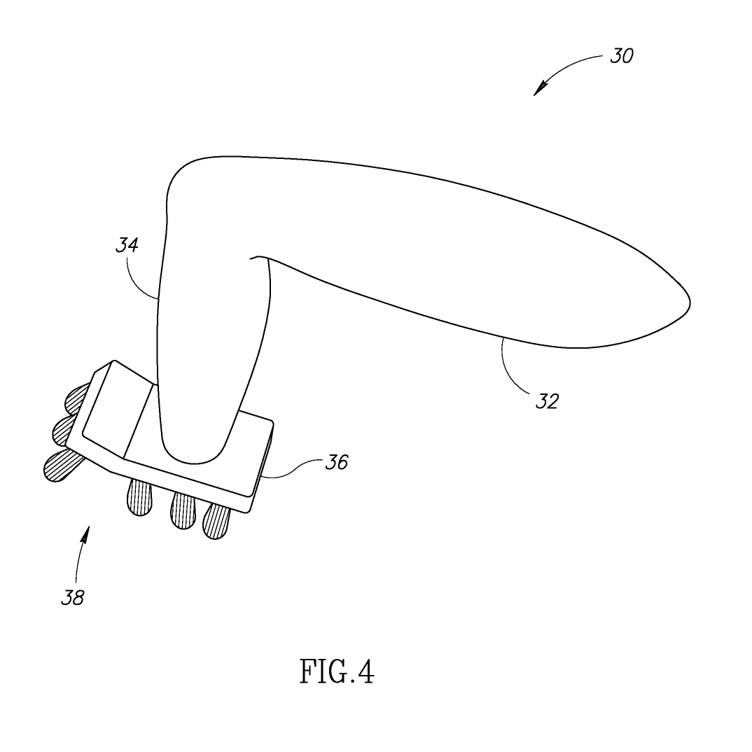

FIG. 4 is a perspective view of the present invention illustrated in FIG. 3. Riser/handle 32/34 may be circular in cross-section, or may have other cross-sectional shapes such as oval, triangle, hexagon, or octagon, or irregular shape. The shape of handle 32 and riser 34 shown in these figures are for illustrative purposes only, and they may have shapes and sizes different from those illustrated.

As further illustrated in FIG. 4, handle 32 is preferably shaped for easy and comfortable gripping, and may, for example, be curved or have an ergonomic shape that renders the cleaning device easier to grasp. Handle 32 will typically be long and wide enough so that a user may easily grasp it, but not so long as to become unwieldy. Various lengths of handle 32 are possible and perhaps preferable for particular applications (e.g, use with larger or smaller vessels). Handle 32 may also include a gripping portion, formed from a combination of materials including, for example, plastic, foam, gel, or other various moldable mediums to make the handle more comfortable or more easily held. Similarly, the size and shape of riser 34 may vary significantly.

In accordance with a preferred embodiment, handle 32, riser 34, foot 36, and cleaning element 38 are preferably made from substantially rigid material, such as wood, stainless steel, nylon or plastic. However, it may also be desirable to have a certain amount of flexibility in one or more of these components of cleaning device 30. For example, riser 34 may be made of a flexible material, such as a flexible plastic, rubber, nylon, or any other appropriate material. The flexibility or stiffness of handle/riser 32/34 may permit foot 36 and cleaning element 38 to be positioned at the corners and edges to permit proper cleaning.

Additionally, as illustrated and discussed more fully below, cleaning element 38 may comprise individual filaments made from synthetic or natural fibers, or it may be made from a solid material such as a sponge or other material suitable for cleaning the residue from inside a frothing vessel without damaging the inside surface 29 or edges 27 of frother 20 (see FIG. 2).

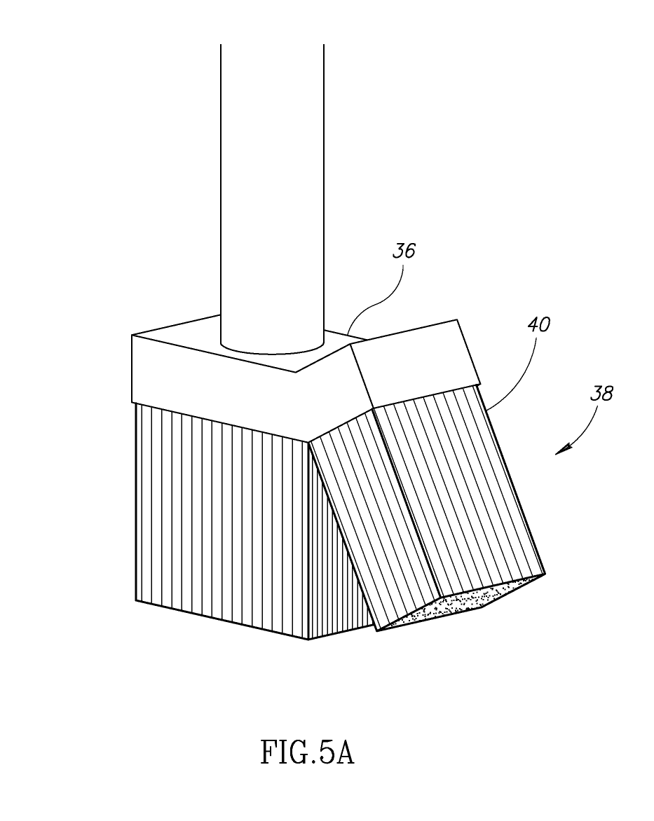

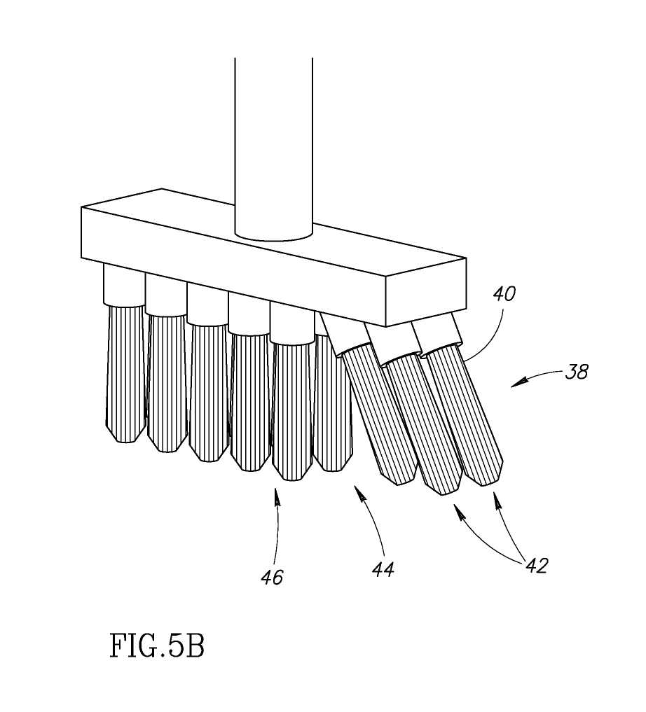

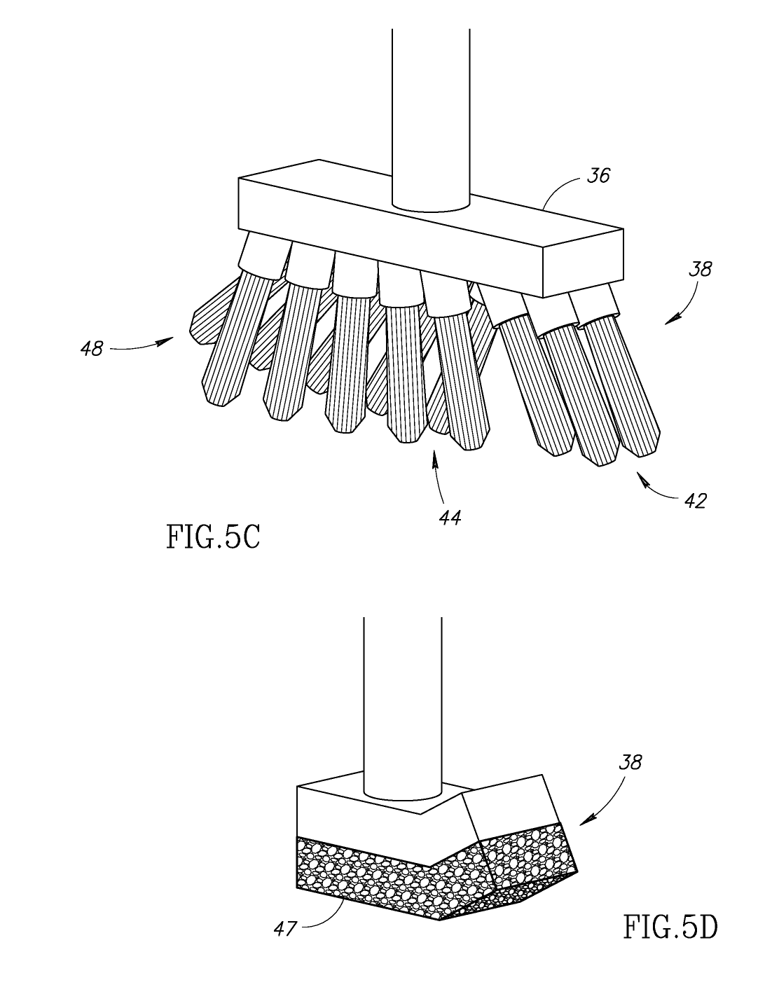

FIG. 5A illustrates an alternative embodiment of cleaning element 38 comprising a plurality of filaments or bristles, each an individual bristle 40. Individual bristle 40 may be made of nylon, plastic, steel, or any other suitable filament material. Each bristle 40 may be of the same lengths, as shown in FIG. 5A, or may be of varying lengths, or combinations thereof. Bristle filament 40 may extend from the end surface of foot 36 as well as outwardly along part of the length of foot 36. Bristle filament 40 may also extend at various angles. The bristles 40 of cleaning element 38 allow a user to effectively clean the various surfaces of the vessel with differing contours.

Bristle 40 of cleaning element 38 may be formed integrally with the molding or forming of foot 36. Alternatively, bristle filament 40 may be attached by a variety of approaches, for example, by inserting and adhering bristle filament 40 into holes in foot 36, by affixing bristle filament 40 to the exterior surface of foot 36, or by stitching bristle filament 40 directly onto foot 36. In other embodiments, cleaning element 38 may be formed separately from foot 36 and then subsequently affixed to foot 36. Glue, sonic welding, thermo-bonding, clips are just some examples of how the bristles 40 may be affixed to the foot 36.

FIG. 5B illustrates another embodiment of cleaning element 38 with bristles 40 arranged in a plurality of clusters 42 with multiple bristles 40 in each cluster 42. As is shown in FIG. 5B, some bristles may be substantially parallel, as illustrated with cluster 44 and cluster 46, while another cluster 42 may be at a first angle with other bristles or clusters 44 and/or 46.

FIG. 5C illustrates yet another embodiment of cleaning element 38 wherein bristles extend at various angles from foot 36. For example, a third cluster of bristles 48 may be at a second angle to the first cluster of bristles 42 and at a third angle to the second cluster of bristles 44. The first, second, and third angles may be the same or different from one another. In other embodiments, there may be fourth or fifth clusters of bristles (not shown) at fourth and fifth angles, and so on. These angles may vary, such that the design and orientation allow a user to reach and clean the corners, edges, and surfaces of a frothing vessel.

FIG. 5D is a perspective view of still another embodiment of cleaning element 38, wherein cleaning element 38 comprises a sponge 47. Cleaning element 38 may also be made from other materials, suitable for wiping and cleaning the inside surface of a frothing vessel and removing residue left by the frothing process.

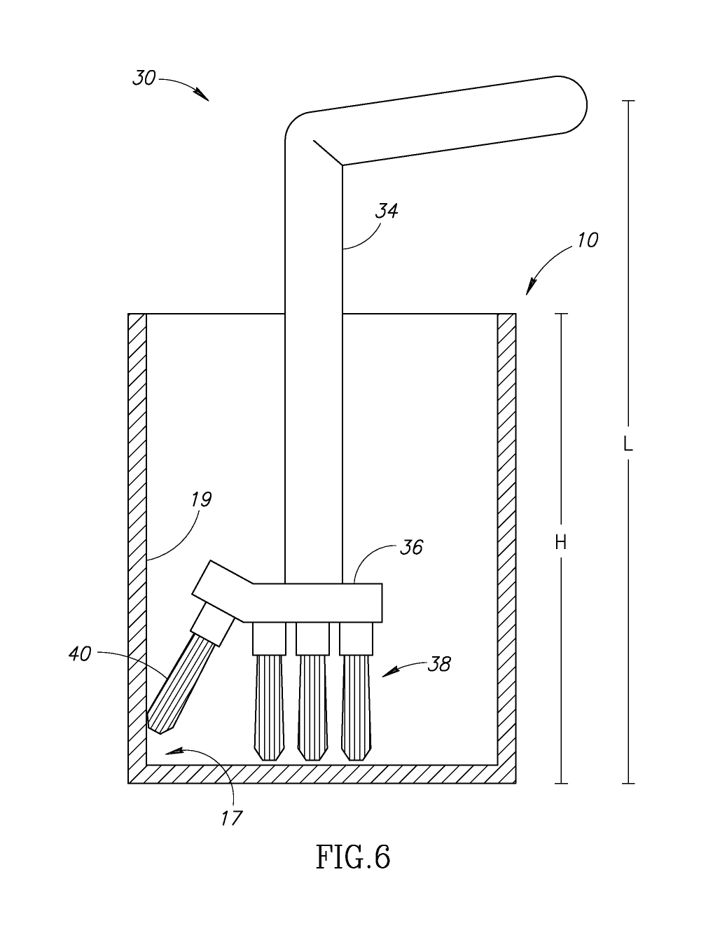

FIG. 6 illustrates schematically, an embodiment of the present invention 30 placed inside the vessel 10 (in sectional view) as previously discussed and illustrated in FIG. 1. Riser 34 preferably has a length to sufficiently deliver foot 36 and cleaning element 38 to the bottom of vessel 10. In general, if vessel 10 has a height “H”, then cleaning device 30 will preferably have a length “L” defined by the relation: “L is greater than H.”

As is shown in FIG. 6, the size and shape of the cleaning element 38 are such that it can be maneuvered to clean edges 17 and surfaces 19 of the bottom of vessel 10. The user may sweep the bristles 40 along the inside edges 17 and surfaces 19 to clean the vessel 10.

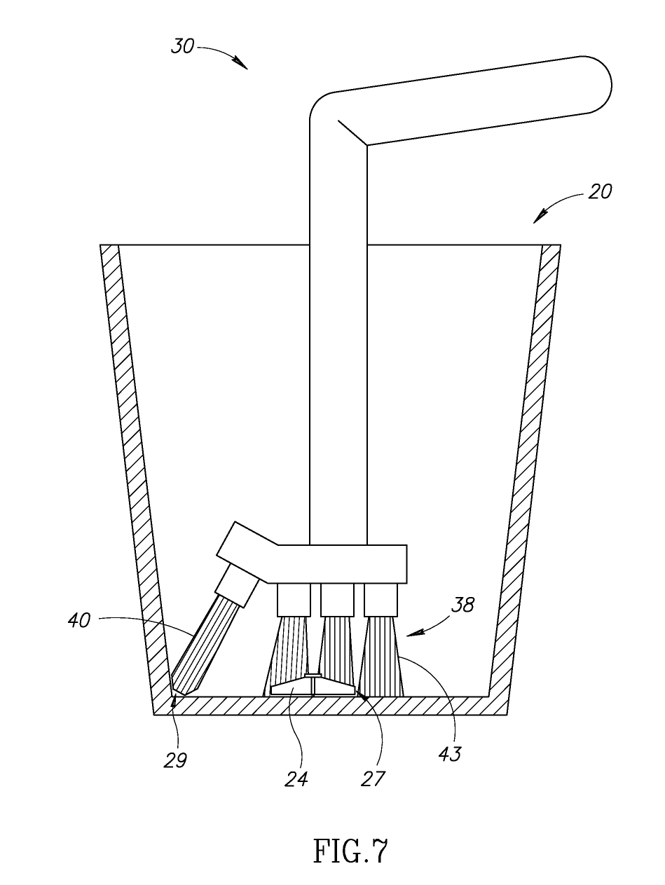

FIG. 7 illustrates schematically, a sectional view of an embodiment of the present invention 30 in use with a stand-alone frothing vessel 20 as previously discussed and illustrated in FIG. 2. As is shown in FIG. 7, bristles 40 of cleaning element 38 has an angle and length that permits it to reach the corners, edges and surfaces 29 of the frothing vessel 20. Another bristle 43 has an angle and length that permits it to clean the edges 27 of the raised middle portion created by stirring device 24 on the bottom of the frother 20.

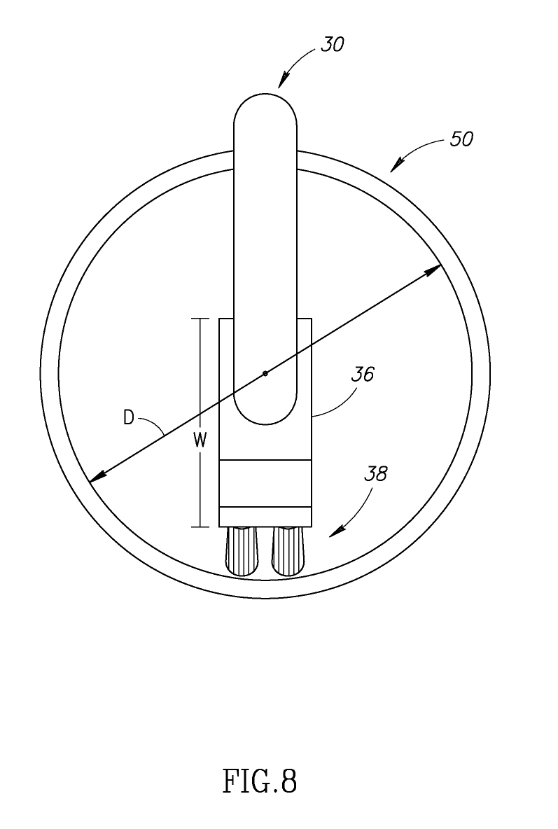

FIG. 8 is a top view looking into vessel 50 with cleaning device 30 positioned inside vessel 50. As an example, FIG. 8 shows vessel 50 as having a circular shape. It is understood that frothers and vessels may come in any shape. In general, if vessel 50 has a diameter “D”, then foot 36 will have a width “W” defined by the relation: “W is greater than ½ D”. In addition, cleaning element 38 preferably extends from foot 36 beyond the radius of standard vessel 50 so that the bottom corners, edges and surfaces of vessel 50 can be easily and quickly cleaned by moving the cleaning device 30 around the inside circumference of vessel 50.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow. The embodiments of the invention in which an exclusive property or privilege is claimed are defined as follows:

1. A device for cleaning a frothing vessel, comprising:
a riser having a proximal end and a distal end,
a handle coupled to the proximal end of the riser,
a foot coupled to the distal end of the riser, and
a cleaning element coupled to the foot.

2. The device of claim 1, wherein at least one of the group of the riser, the handle, the foot, and the cleaning element is formed integrally with another one of the group of the riser, the handle, the foot, and the cleaning element.

3. The device of claim 1, wherein at least one of the group of the riser, the handle, the foot, and the cleaning element is releasably attached with another one of the group of the riser, the handle, the foot, and the cleaning element.

4. The device of claim 1, wherein at least one of the group of the riser, the handle, the foot, and the cleaning element is made of a polymer.

5. The device of claim 4, wherein the polymer is plastic.

6. The device of claim 5, wherein the plastic is flexible plastic.

7. The device of claim 4, wherein the plastic is rigid plastic.

8. The device of claim 4, wherein the polymer is nylon.

9. The device of claim 1, wherein at least one of the group of the riser, the handle, the foot, and the cleaning element is made of a metal.

10. The device of claim 9, wherein the metal is stainless steel.

11. The device of claim 1, wherein at least one of the group of the riser, the handle, the foot, and the cleaning element is made of a wood.

12. The device of claim 1, wherein at least one of the group of the riser, the handle, the foot, and the cleaning element is made of an organic material.

13. The device of claim 1, wherein the cleaning element comprises a plurality of bristles.

14. The device of claim 13, wherein at least one bristle in the plurality of bristles is longer than another one of the plurality of bristles.

15. The brush of claim 13, wherein
a first bristle in the plurality of bristles is at a first angle to the foot,
a second bristle in the plurality of bristles is at a second angle to the foot, and
wherein the first and second angles are different.

16. The device of claim 1, wherein the cleaning element comprises an abrasive surface.

17. The device of claim 1, wherein the cleaning element comprises a sponge.

18. The device of claim 1, wherein the handle further comprises a grip portion.

19. The device of claim 18, wherein the grip portion is made of a moldable medium.

20. The device of claim 1, wherein
the foot has a proximal end coupled to the riser and a distal end, and
wherein the foot has an angular bend between the proximal and distal ends.
